(19) United States
(12) Patent Application Publication
(10) Pub. No.: US 2008/0136842 A1
(43) Pub. Date: Jun. 12, 2008

(54) Method and Apparatus for Converting Graphics Display Information Including Partial Scaling and Area Expansion

(75) Inventor: Yeqing Wang, Horsham, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/609,689

(22) Filed: Dec. 12, 2006

(51) Int. Cl. G09G 5/00

(52) U.S. Cl. 345/660

(57) ABSTRACT

A method and device for converting graphics display information from a first display format to a second display format using partial scaling and area expansion and fill. The method includes scaling the graphics display information from the first format to an intermediate format that is larger than the first format but smaller than the second format. The method also includes expanding one or more dimensions of the intermediate display format and filling in the expanded areas in a manner that increases the scaled display information to that of the second display format. The device includes a scaler for scaling the display information from the first format to the intermediate format and an extender for increasing the display information from the intermediate display format to the second display format.

### BACKGROUND OF THE INVENTION

1. Field of the Invention

The invention relates to graphics for display. More particularly, the invention relates to methods and apparatus for scaling and extending graphics display information, so that graphics display information can be converted from one display format (e.g., aspect ratio) to another display format (e.g., another aspect ratio).

2. Description of the Related Art

The aspect ratio of graphics or graphics information displayed on a device, such as a television, is a numerical expression of the width to height of the graphics display. For standard television display formats, e.g., National Television System Committee (NTSC) and Phase Alternation Line (PAL), the aspect ratio is 4:3, i.e., a “4” unit width corresponding to a “3” unit height, proportionally, regardless of the actual size of the screen. For wide screen digital television (DTV) formats for high definition television (HDTV) and some enhanced definition television (EDTV) formats, the aspect ratio is wider: 16:9, i.e., a “16” unit width corresponding to a “9” unit height, proportionally, regardless of the actual size of the screen.

Since there exists both graphics information meant for display on devices with a 4:3 aspect ratio and graphics information meant for display on devices with a 16:9 aspect ratio, graphics information content providers and service providers often provide graphics information in both aspect ratio formats or convert graphics information between different aspect ratios. Conventional methods for converting graphics information typically require that a portion of the converted graphics information for display be removed or cut off. Some conventional conversion methods use linear conversion techniques to fill out the final display window or screen, however such methods introduce distortion. Such distortion has an especially negative effect on distortion-sensitive graphics information, such as logos and other graphic-shaped images. Yet, conventional methods for converting graphics information typically apply the same type or amount of aspect ratio conversion to the graphics information as it is being converted from one aspect ratio to another, e.g., from a 4:3 aspect ratio to a 16:9 aspect ratio.

When converting display information from a first aspect ratio, e.g., a 4:3, to a second aspect ratio, e.g., a 16:9, conventional conversion methods and devices perform a single conversion or scaling process, e.g., one linear scaling process using a single linear scaling algorithm, until the display information is converted completely from the first format to the second format. Using a linear scaling process introduces distortion to the scaled display information, especially when converting from a 4:3 aspect ratio to a 16:9 aspect ratio. Also, the distortion introduced by a linear scaling process or other conventional scaling processes is more pronounced if the scaled display information includes distortion-sensitive graphics information such as company logos and some graphics.

### BRIEF DESCRIPTION OF THE DRAWINGS

FIG. 1 is a representation of display information in one display format;

FIG. 2 is a block diagram of a device for use in converting graphics display information from a first display format to a second display format using partial scaling and expansion;

FIG. 3 is another representation of the display information shown in FIG. 1 shown in a second format;

FIG. 4 is yet another representation of the display information shown in FIGS. 1 and 3 shown in a third format; and

FIG. 5 is a flow chart of a method for converting graphics display information from a first display format to a third display format using scaling and expansion.

### DETAILED DESCRIPTION

In the following description, like reference numerals indicate like components to enhance the understanding of the graphics scaling method and apparatus through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

Many conventional methods and apparatus for converting graphics information or graphics display information from one format to another, e.g., from a first aspect ratio to a second aspect ratio, typically perform such conversion directly from the first format to the second format, using a single conversion process. That is, typically, a single linear scaling or other similar conversion process, using a single scaling algorithm, is performed directly until the first display format is converted to the second display format. Display information is any information suitable for display on an end-user device, such as a television or computer monitor and typically includes video images, still images, text or graphics.

Such a direct scaling process typically introduces a certain amount of distortion to the display information. The amount of distortion introduced varies depending on certain factors, such as the amount of scaling performed on the display information. For example, a scaling process that converts display information from a 4:3 aspect ratio to a 16:9 aspect ratio involves more scaling and thus can introduce more distortion than a scaling process that converts display information from a 4:3 aspect ratio to a 14:9 aspect ratio, which involves less scaling.

Also, the particular content of the display information can affect how tolerable a given amount of distortion is to a viewer. For example, display information that includes more distortion-sensitive information typically is more susceptible to distortion compared to display information that includes more distortion-nonsensitive information. Distortion-sensitive information typically includes logos and other graphic-oriented content. Distortion-nonsensitive information typically includes text and other non-graphics content. Typically, display information having more distortion-sensitive information usually can not be scaled as much as display information with less distortion-sensitive information before the display information becomes relatively intolerable to a viewer.

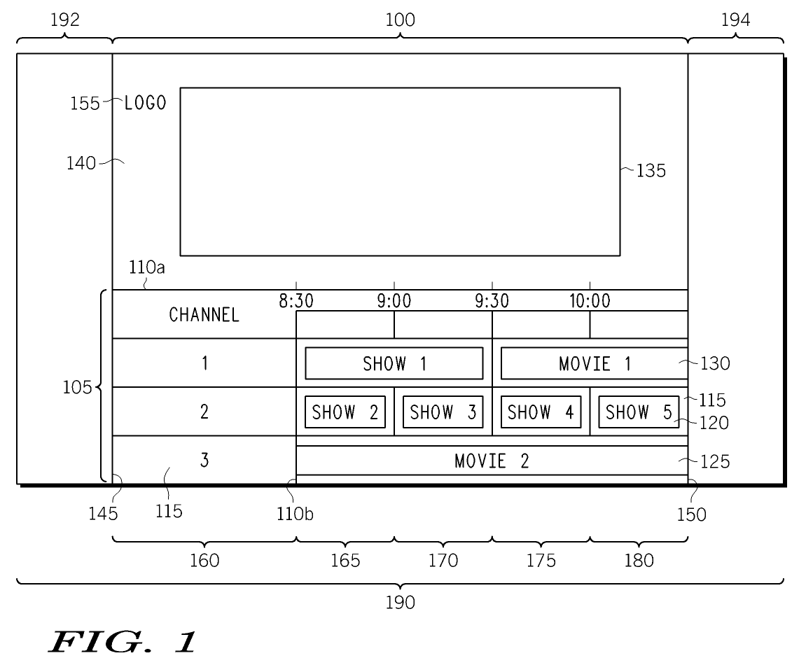

FIG. 1 is a representation of display information 100 in a first format. Display information 100 is television channel guide display. Channel guide area 105 includes horizontal lines 110a and vertical lines 110b. It should be noted that channel guide area 105 includes multiple horizontal and vertical lines while only two are designated with numbers in FIG. 1 for the sake of clarity. Channel guide area 105 also includes a background area 115 over which the horizontal lines 110a and vertical lines 110b are superimposed. The horizontal lines 110a and vertical lines 110b are typically of a different color or shade from the color of background 115. As an example, horizontal lines 110a and vertical lines 110b are white and background 115 is black.

Channel guide area 105 also includes times such as 8:30, 9:00 etc. Interspersed in the grid formed by horizontal lines 110a and vertical lines 110b is text information such as the word “Channel” and the channel numbers 1, 2 and 3. In addition, bars or blocks are also superimposed over the grid to designate when certain programs begin and end on certain channels. For example, Channel 1 will show Show 1 from 8:30 to 9:30 and then show Movie 1 from 9:30 past 10:30 as designated by block 130. Channel 2 will show Show 2 from 8:30 to 9:00, Show 3 from 9:00 to 9:30, Show 4 from 9:30 to 10:00 and Show 5 from 10:00 to 10:30 as designated by block 120. Finally, channel 3 will show Movie 2 from before 8:30 until past 10:30 as designated by block 125. In one illustrative example, blocks 120, 125 and 130 are the same shade in color. In other illustrative examples, blocks 120, 125 and 130, as well as the other blocks not specifically designated, may be of different shades or colors.

In addition to channel guide area 105, display 100 includes a preview window 135. Preview window 135 shows whatever is playing on a particular channel at a particular time or it might show advertisements for upcoming shows on select channels. Preview area 135 is distinguishable from channel guide area 105 in that it typically shows video while channel guide area is comprised of graphics and text. Preview window 135 is superimposed over another background 140. In one example, background 140 is black.

Display 100 also includes a vertical left edge 145 and a vertical right edge 150. These edges are the left-most and right-most pixel data for display 100. The pixel values on left-edge 145 will include only one of three possible sets of values for the illustrative display 100. The pixel values on left-edge 145 will correspond to either background 140, horizontal lines 110a or background 115 depending on their vertical location. Similarly, the pixel values on right-edge 150 will correspond to either background 130, horizontal lines 110a, block 130, background 115 or block 125 depending on their vertical location. Blocks 125 and 130 extend to right-edge 150 while block 120 does not. Instead, background 115 covers the small area between block 120 and right-edge 150. It should be noted that alternative grids, blocks and diagrams may be used to display channel and time information in channel guide area 105.

Display 100 also includes a logo 155. Logo 155 will typically be the name of the vendor providing the information and data in channel guide area 105 or preview window 135. Logo 155 is typically superimposed over background 140.

The illustrative channel guide area 105 shown in FIG. 1 is divided into five horizontal sections. Section 160 holds the channel numbers. Section 165 represents the time slot from 8:30 to 9:00. Section 170 represents the time slot from 9:00 to 9:30. Section 175 represents the time slot from 9:30 to 10:00 and section 180 represents the time slot from 10:00 to 10:30.

Display 100 is in a first format. In this example, the first format of display 100 is a 4:3 aspect ratio. That is, display 100 is 4 units horizontal for every 3 units vertical. Display 100 is superimposed over a second format 190. Second format 190 is a second aspect ratio of 16:9. For the purposes of this discussion, display 100 is drawn in a 12:9 aspect ratio so that the vertical edges of display 100 and display 190 align. It should be noted that a 12:9 aspect ration is the same as the 4:3 aspect ratio.

Since display 190 is wider than display 100, there will be two areas 192 and 194 that are not covered by display 100 in FIG. 1.

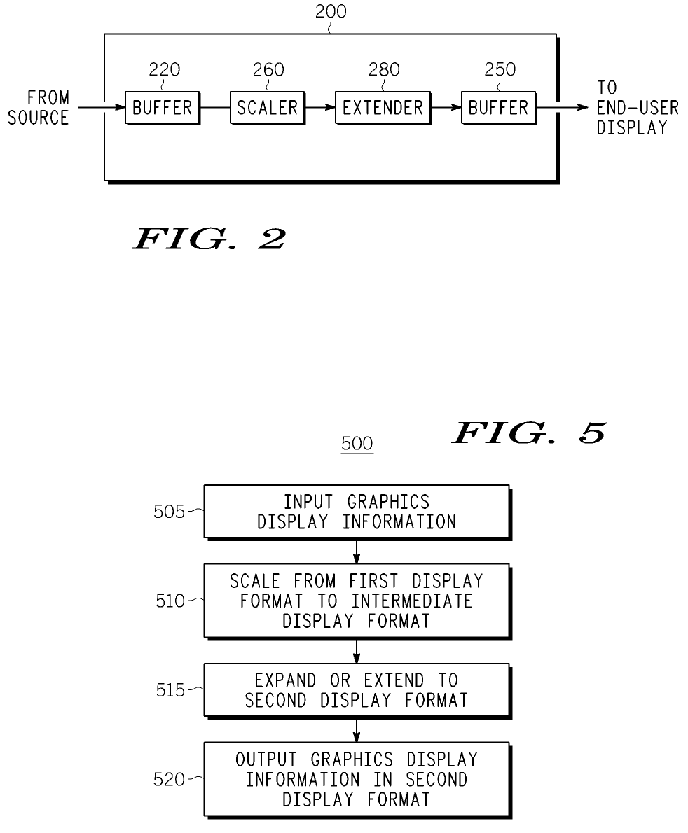

Referring to FIG. 2, shown is a block diagram of a device or processing device 200 for converting display information or graphics display information from a first display format to a second display format, e.g., from a first aspect ratio to a second aspect ratio, using partial scaling and area expansion. For purposes of discussion herein, display information or graphics display information includes, e.g., video information and/or graphics information. Also, for purposes of discussion herein, a display format includes any suitable format for displaying graphics display information, e.g., various aspect ratios, such as 4:3, 14:9 and 16:9 aspect ratios or various resolutions such as the number of horizontal or vertical pixel lines per image. To put it another way, an attribute of a display format includes data related to the length and width of the display information such as aspect ratio and resolution. An attribute in one display format can be greater than, less than or equal to an attribute in a second display format (e.g., 16/9 is greater than 4/3; 1,024 pixel length is greater than 720 pixel length).

The device 200 can be partially or completely any suitable device or subsystem (or portion thereof) for receiving and/or processing graphic information or graphic display information. For example, such devices include any signal converter or decoder (set-top) box or other suitable computing device or video device, including a residential gateway, an internet protocol (IP), satellite or cable digital video recorder, a computer, or a home media server system. All or a portion of the device 10 can be comprised of any suitable structure or arrangement, e.g., one or more integrated circuits.

The device 200 includes a first or input buffer or memory unit 220, and a scaler 260 coupled to the output of the input buffer 220. Coupled to the output of scaler 260 is an extender 280. The device 200 also may include a second or output buffer or memory unit 250 coupled to the output of the extender 280. One or more of the input buffer 220, the output buffer 250, and one or more of the scaler 260 and the extender 280 can be comprised partially or completely of any suitable structure or arrangement, e.g., one or more integrated circuits. Also, it should be understood that the device 200 includes other components, hardware and software (not shown) that are used for the normal operation of features and functions of the device 200 not specifically described herein. Examples included tuners, decoders, decrypters etc.

The device 200 can be partially or completely configured in the form of hardware circuitry and/or other hardware components within a larger device or group of components. Alternatively, the device 200 can be partially or completely configured in the form of software, e.g., as processing instructions or one or more sets of logic or computer code. In such configuration, the logic or processing instructions typically are stored in a data storage device (not shown), which typically is coupled to a processor or controller (not shown). The processor accesses the necessary instructions from the data storage device and executes the instructions or transfers the instructions to the appropriate location within the device 200.

One or more of the input buffer 220 and the output buffer 250 can be any suitable buffer or memory device, including random access memory (RAM) devices, read-only memory (ROM) devices and Flash memory devices. Also, although the input buffer 220 and the output buffer 250 are shown within the device 200, either one or both buffers can be located external to the device 200.

The device 200, via the input buffer 220, receives graphics information from an appropriate source (not shown) of graphics information, e.g., graphics information generated locally from a device, such as a set-top box or DVD player, or graphics information generated remotely from a service provider of video stream content that includes graphics and/or graphics information. The service provider can be a television service provider (e.g., a national or local television network), a cable television service provider, an Internet service provider, a satellite broadcast system service provider, or other suitable service provider. The device 200, via the output buffer 250, outputs information to an end-user display (not shown), which can be any suitable display device, such as a television or a computer monitor.

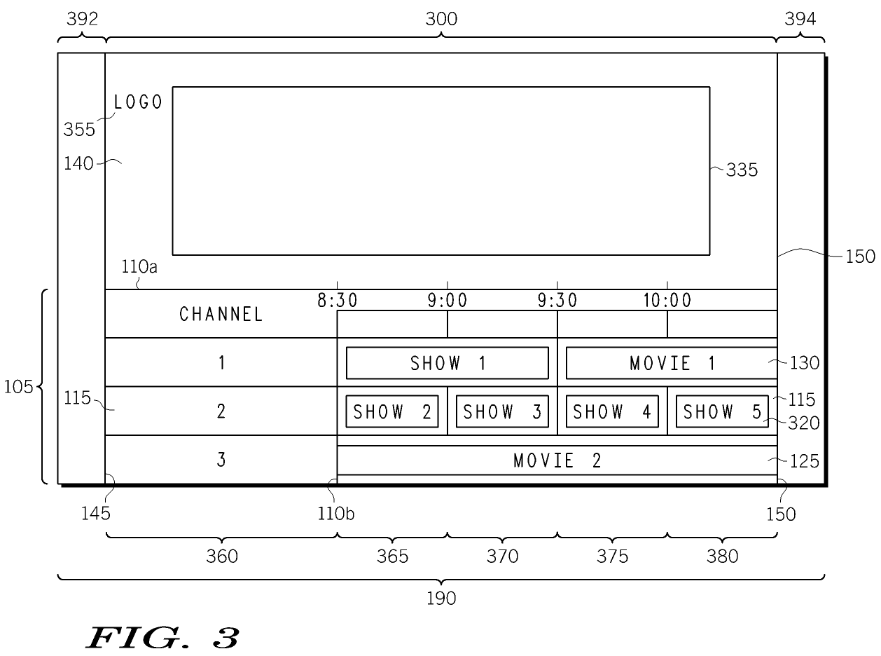

FIG. 3 is another representation of the display information 100 shown in FIG. 1 shown in a second format 300. Display 300 is generated by inputting display 100 into device 200 shown in FIG. 2. Display 100 is first input into buffer 220 and then into scaler 260. The output of scaler 260 is display 300.

As shown in FIG. 3 in comparison to FIG. 1, display 300 is wider than display 100. Thus scaler 260 has scaled or multiplied the horizontal dimensions of display 100 into display 300. Thus, the sections 360, 365, 370, 375 and 380 are wider in comparison to sections 160, 165, 170, 175 and 180, respectively, while the vertical dimensions of display 100 and display 300 are held constant (e.g., no vertical scaling when generating display 300 from display 100). In addition, logo 155 is scaled to generate a wider logo 355 and preview window 135 is scaled to preview window 335. Thus, logo 355 and preview window 335 are wider than logo 155 and preview window 135, respectively.

Since all of the data in display 100 is scaled, display 300 will maintain the same relative spacing as in display 100. For example, if the word “Channel” is centered in section 160, it will also be centered in section 360. Similarly, the pixel values along edges 145 and 150 in displays 100 and 300 will be the same, respectively.

Scaler 260 can accept any of a number of display formats from buffer 220 and output any of a number of different display formats depending on its construction and programming. For example, scaler 260 could receive display 100 with its 4:3 aspect ratio and output display 300 with a 14:9 aspect ratio. The output of scaler 260 is an intermediate format.

Like FIG. 1, FIG. 3 is shown over a different format represented by 190. This different format 190 could have an aspect ratio of 16:9. Since the intermediate format of display 300 has an aspect ratio of 14:9, there will be areas 392 and 394 that will not have any display information from display 300. However, areas 392 and 394 are smaller, or less wide, than areas 192 and 194 in FIG. 1.

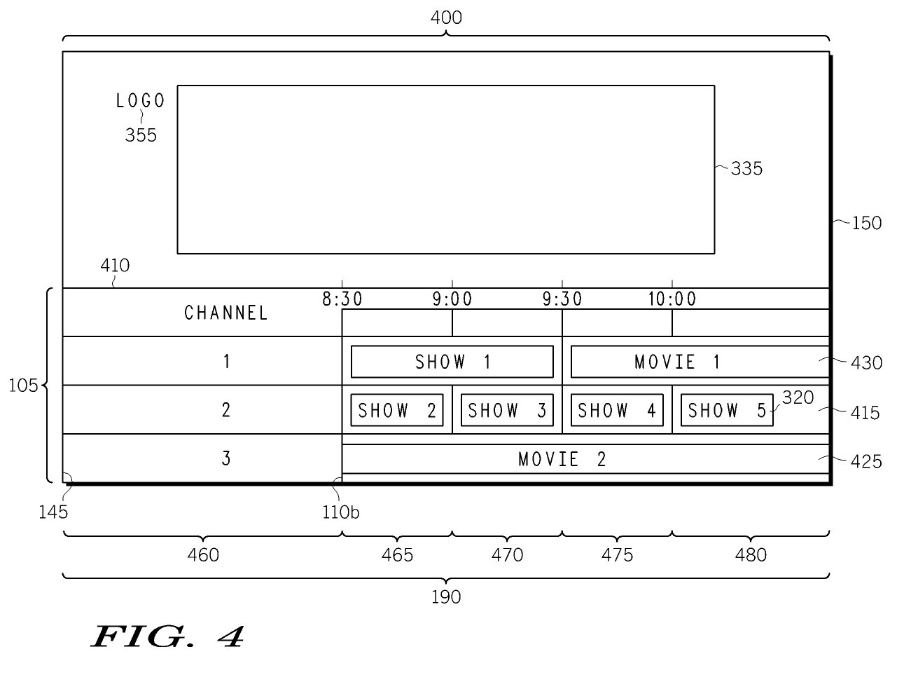

The intermediate format shown in FIG. 3 is output from scaler 260 and input into extender 280. Extender 280 takes display 300 and generates display 400 shown in FIG. 4. Display 400 is generated by taking the pixel data on edges 145 and 150 and copying it to fill in areas 392 and 394 in FIG. 3. That is, the pixel data for background 140, background 115 and horizontal lines 110a is copied into area 392. The net effect is to increase the margin between the left-edge 145 and the left-edge of preview window 335 and the “C” in the word “Channel.” This process also “lengthens” horizontal lines 110a. Due to this back filling into area 392, the word “Channel” that was centered in section 360 will appear off-center and to the right in section 460.

Extender 280 performs the same operation on right-edge 150. Thus, pixel data for backgrounds 140 and 115 and horizontal lines 110a will be copied in area 394. Similarly, blocks 130 and 125 will be made longer by extending their respective pixel data into area 394. This cause the text “Movie 1” and “Movie 2” to appear off-center and to the left.

Block 320 will also no longer be centered in the grid box between 10:00 and 10:30. Background 115 will be copied to make a wider background 415 of the same pixel data as background 115 in FIG. 3. This will cause block 320 to appear off-center and to the left in its respective grid space. Thus, sections 460 and 480 will be wider than sections 360 and 380, but because only pixel data at edges 145 and 150 is copied, sections 465, 470 and 475 will be the same width as sections 365, 370 and 375. Also, the relative spacing of objects and letters within sections 465, 470 and 475 will be substantially the same as the relative spacing of objects and letters within sections 365, 370 and 375, respectively.

Referring now to FIG. 5, shown is a method 500 for converting graphics display information from a first display format to a second display format using partial scaling and area expansion or edge extension. The method 500 includes the step 505 of inputting graphics display information or graphics information into the processing device 200. As discussed previously herein, the graphics display information is input from a suitable source (not shown) that is operably connected to the device 200. Alternatively, the graphics display information is generated, at least partially, by or previously stored in the processing device 200.

The processing device 200 receives display information generated or transmitted from the source or, alternatively, generated from within the device 200. The input buffer 220 stores, at least temporarily, all or a portion of the received display information, which has a first format. For example, the display information can have a 4:3 aspect ratio or other suitable scale format. The input buffer 220 provides or transmits the stored display information to the scaler 260 at a rate that allows the scaler 260 to suitably process the display information, i.e., convert the display information from the first format to an intermediate format, e.g., to a 14:9 aspect ratio.

The method 500 includes a step 510 of scaling the display information from the first display format to an intermediate display format using a scaling process. In this step, the scaler 260 scales the display information from the first format to the intermediate format using a suitable scaling process, e.g., a linear scaling algorithm. The intermediate format is a display information display format whose attribute is larger or greater than the attribute of the first format but smaller or less than the attribute of the second format. For example, if the display information is to be converted from a 4:3 aspect ratio (first format) to a 16:9 aspect ratio (second format), the intermediate format can be a 14:9 aspect ratio or other suitable aspect ratio that is greater than the 4:3 aspect ratio and less than the 16:9 aspect ratio.

By converting the display information from the first format to an intermediate format, the scaling step 510 introduces less distortion to the display information than would be introduced by converting the same display information from the first format to the second format, assuming the same scaling process and/or scaling algorithm is used. Typically, the amount of distortion that linear scaling processes and other conventional scaling processes introduce to display information is proportional to the amount or extent of the scaling performed. That is, if scaling display information from a 4:3 aspect ratio to a 14:9 aspect ratio (i.e., an intermediate aspect ratio) introduces one amount of distortion, scaling the same display information from a 4:3 aspect ratio beyond the 14:9 aspect ratio, e.g., to a 16:9 aspect ratio, introduces a greater amount of distortion to the scaled display information.

As discussed hereinabove, the amount of distortion introduced to the display information by the scaling step 510 depends on the content of the display information and the amount of scaling performed on the display information. Therefore, the scaling step 510 desirably scales the display information to an intermediate format that is not beyond the point where too much distortion has been introduced to the display information. Thus, the scaled display information in the intermediate format is not so distorted that it is relatively intolerable to view.

In general, the amount of distortion required to render scaled display information intolerable to a viewer often is subjective. As discussed, the relative effect of introduced distortion depends on several factors, e.g., the amount of scaling performed on the display information and the relative amount of distortion-sensitive information contained in the display information. In the method 20, the amount of partial scaling performed on the display information to convert the display information from the first format to the intermediate format can be determined in several ways. For example, the amount of partial scaling performed on the display information can be based on the initial (first) format of the display information and/or the amount of scaling needed to convert the display information from the first format to the second format. The amount of partial scaling also can be based on a fixed or preselected amount of scaling, which may or may not depend on the initial format and/or the final scaled format.

For example, if the initial format of the display information is a 4:3 aspect ratio, and the final desired format is a 16:9 aspect ratio, the amount of partial scaling necessary to convert the display information from the initial format to the intermediate format can be based on the difference between the initial format and the final format. Thus, the scaler 260 can be configured to convert the display information from the 4:3 aspect ratio to a 14:9 aspect ratio or other suitable aspect ratio between the 4:3 and 16:9 aspect ratios. Alternatively, the scaler 260 can be configured to convert the display information a preset or fixed amount from the 4:3 aspect ratio to an intermediate format, which may not necessarily be the 14:9 aspect ratio. The preset amount may be an absolute amount, or may be based on the specific initial format and/or the second (final) format.

The initial format of the display information can be determined by the scaler 260 or other suitable component in the device 200. Alternatively, the initial format of the display information can be encoded in the display information, e.g., as metadata. Alternatively, the second format can be determined based on acceptable industry standard format conversions. For example, if a certain type of display information typically is converted from a 4:3 aspect ratio to a 16:9 aspect ratio, the scaler 260 and extender 280 can be configured to determine the final format (e.g., 16:9) upon recognition of such type of display information

Alternatively, the amount of acceptable scaling allowed for display information and/or a suitable intermediate display format can be encoded or contained in the display information itself. For example, using metadata or other suitable means, a suitable level of partial scaling, based on an established scaling index or range, can be encoded into the display information by the content provider or the content service provider. Such encoded scaling level information can be read by the scaler 260 or other component within device 200, during the scaling step 510.

Once the display information has been converted from the initial or first format to the intermediate format, the method 500 continues at step 515 to extend or expand at least a portion of intermediately-scaled display information. For example, for display information that initially was converted from a 4:3 aspect ratio to an intermediate 14:9 aspect ratio, the extension step 515 converts the display information from the intermediate 14:9 aspect ratio to a 16:9 aspect ratio.

In the extension or expansion step 515, the extender 280 extends at least one dimension of the intermediate display format so that the expanded display format is equal to the second display format. Typically, based on the manner in which display information often is scaled using conventional linear scaling processes, the expansion step 515 usually extends the sides or the side edges of the intermediate display format display information so that the width is equal to the width of the second display format. This is shown when FIG. 3 is compared to FIG. 4. However, it should be understood that the expansion step 515 can expand or extend any one or more dimensions of the intermediate display format display information.

For example, the step 515 extends the edges of the intermediate format display information, e.g., the left and right edges 145 and 150, respectively, based on the graphics information near the edges of the intermediate format display information. That is, the expansion step 515 extends the left and right edges 145 and 150 of the intermediate format display information. That is left-edge 145 in FIG. 3 is copied so that area 392 in FIG. 3 is replaced with pixel data to generate display 400 in FIG. 4. Similarly, the right edge 150 in FIG. 3 is copied so that area 394 in FIG. 3 is replaced with pixel data to generate display 400 in FIG. 4.

In an alternative implementation, step 515 fills the area with a background color or pattern that is the same or similar to the background color or pattern of the existing portion of the graphics information near left edge 145 and right edge 150. For example, to extend the edges of the intermediate format display information, the background color or pattern can be based on interpolating the areas of the graphics information near the edges of the intermediate format display information.

Once the intermediate display format has been converted to the second display format, the method 500 produces display information or graphics display information in the second format at step 520. By converting the display information from the first display format to the second display format using a scaling step 510, an expansion step 520 the device 2000 and method 500 are able to convert display information in a manner that introduces less distortion to the display information than conventional conversion processes, which typically convert display information directly from the first format to the second format using a single scaling process. Alternatively, by introducing less distortion per given amount of scaling than conventional scaling processes, the device 200 and method 500 can, in general, scale display information by greater amounts while still maintaining tolerable distortion levels.

Although the format conversion device 200 and method 500 have been discussed herein in terms of expanding or extending display information from a first format having a smaller aspect ratio to a second format having a larger aspect ratio than that of the first format, it should be understood that the format conversion device 200 and method 500 can be used to reduce display information from a format having a larger aspect ratio or resolution to a format having a smaller aspect ratio or resolution. In general, one or more portions of the display information, e.g., one or more of the edges of the display information, would be reduced so a corresponding area is removed. The resulting intermediate format display information then would be converted using a scaling process, such as a linear scaling process, that reduces intermediate format display information to the final format, which has smaller attributes than the initial format.

The method shown in FIG. 5 may be implemented in a general, multi-purpose or single purpose processor. Such a processor will execute instructions, either at the assembly, compiled or machine-level, to perform that process. Those instructions can be written by one of ordinary skill in the art following the description of FIG. 5 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the graphics scaling method and apparatus herein described without departing from the spirit and scope of the invention as defined by the appended claims and their full scope of equivalents.

1. A computer program embodied in a computer-readable medium for converting display information from a first display format to a second display format, the program comprising:
instructions for scaling at least one dimension of the display information from the first format to an intermediate display format, wherein the intermediate display format has an attribute that is greater than an attribute of the first display format and less than an attribute of the second display format; and
instructions for increasing at least a portion of the attribute of the intermediate display format by an amount approximately equal to the difference between the attribute of the second display format and the attribute of the intermediate display format, wherein the increasing instructions convert the intermediate display format to the second display format.

2. The program as recited in claim 1, wherein the intermediate display format includes data with respect to at least one edge, and wherein the increasing instructions further comprise instructions for extending the at least one edge of the area of the intermediate display format.

3. The program as recited in claim 2, wherein the extending instructions further comprise instructions for copying the data with respect to the at least one edge.

4. The program as recited in claim 2, wherein the increasing at least a portion of the attribute of the intermediate display format includes interpolating a color of an area of the display information at the at least one edge of the area of the intermediate display format.

5. The program as recited in claim 1, wherein the scaling instructions are based on scaling information encoded in the display information.

6. The program as recited in claim 1, wherein the first display format further comprises a 4:3 aspect ratio, and wherein the second display format further comprises a 16:9 aspect ratio.

7. The program as recited in claim 8, wherein the intermediate display format further comprises a 14:9 aspect ratio.

8. A device for converting display information from a first display format to a second display format comprising:
a memory buffer for storing at least a portion of the display information received by the device;
a scaler for converting the display information from the first display format to an intermediate display format, wherein the intermediate display format has an attribute that is greater than an attribute of the first display format and less than an attribute of the second display format, and
an extender for extending at least one edge of the intermediate display format in such a way that the intermediate display format is converted to the second display format.

9. The device as recited in claim 8, wherein the extender extends the at least one edge of the intermediate display format by copying data associated with the at least one edge.

10. The device as recited in claim 8, wherein the extender extends the at least one edge of the intermediate display format by interpolating at least a color of an area at the at least one edge of the intermediate display format.

11. The device as recited in claim 8, wherein the device converts the display information from a 4:3 aspect ratio to a 16:9 aspect ratio.

12. The device as recited in claim 8, wherein the scaler converts the display information from a 4:3 aspect ratio to a 14:9 aspect ratio, and wherein the extender converts the display information from a 14:9 aspect ratio to a 16:9 aspect ratio.

13. The device as recited in claim 8, wherein the extender is implemented in software executed by a computer.

14. The device as recited in claim 8, wherein the extender is implemented in hardware.

15. The device as recited in claim 8, wherein the device is contained in a set-top box.

16. The device as recited in claim 8, wherein at least a portion of the device further comprises an integrated circuit.

17. The device as recited in claim 8 wherein at least one of the attributes is a resolution.
